(19) United States
(12) Patent Application Publication
(10) Pub. No.: US 2025/0337635 A1
(43) Pub. Date: Oct. 30, 2025

(54) NODE ELECTION METHODS AND APPARATUSES, STORAGE MEDIA, AND ELECTRONIC DEVICES

(71) Applicant: BEIJING OCEANBASE TECHNOLOGY CO., LTD., Beijing (CN)

(72) Inventors: Zhenkun YANG, Hangzhou (CN); Fusheng HAN, Hangzhou (CN); Hao LIU, Hangzhou (CN); Jinliang XIAO, Hangzhou (CN); Debin JIA, Hangzhou (CN)

(21) Appl. No.: 18/871,436

(22) PCT Filed: Jul. 27, 2023
(86) PCT No.: PCT/CN2023/109513

§ 371 Date: Dec. 3, 2024

(30) Foreign Application Priority Data
Aug. 1, 2022 (CN) 202210916766.9

(51) Int. Cl. H04L 41/0668; G06F 16/27; H04L 41/00

(52) U.S. Cl. CPC H04L 41/0668; G06F 16/27; H04L 41/30

(57) ABSTRACT

This specification discloses node election methods and apparatuses, storage media, and electronic devices. First, a target node device determines status information of all node devices when detecting that a master node device in a current term meets a predetermined resignation condition. Then, a candidate node device is determined from all the node devices based on the status information of all the node devices. Then, a voting request is broadcast to other node devices if it is determined that the candidate node device is the target node device. Broadcasting the voting request is skipped if it is determined that the candidate node device is another node device, and voting is performed for the another node device based on the determined candidate node device when a voting request that is broadcast by the another node device is received.

### TECHNICAL FIELD

This specification relates to the field of computer technologies, and in particular, to node election methods and apparatuses, storage media, and electronic devices.

### BACKGROUND

Currently, distributed systems each are usually composed of a plurality of node devices (for example, databases). Data are divided into a plurality of data shards based on predetermined rules. The data shards refer to data obtained by scatter storage of data stored in a database to a plurality of node devices based on a certain dimension. Each data shard is stored in different node devices in a way of a plurality of copies. If a certain node device fails, the same copy on another node device can be operated, thereby preventing the entire system from crashing due to the failure of one node device. To avoid a conflict caused when a plurality of node devices perform a read-write operation on the same data, a master node device needs to be elected from the node devices to perform the read-write operation on the data.

However, in an existing election algorithm, when node devices detect that a master node device fails, each of the node devices usually broadcasts a voting request for the node device to become a master node device to other node devices. If each of a plurality of node devices broadcasts, within a short time, a request for electing the node device as a master node device, a case that the plurality of node devices each cannot be agreed as a master node device by more than half of the node devices may occur. In this case, the node devices need to re-elect a master node device. However, in the re-election of a master node device, a case that each of the plurality of node devices broadcasts, within a short time, for electing the node device as a master node device may still occur. As a result, it cannot be ensured that a master node device is elected from the node devices within a determined time. This causes the distributed system to be unavailable for a long time.

Therefore, how to ensure that a master node device is elected from the node devices within the determined time is an urgent problem to be solved.

### SUMMARY

This specification provides node election methods and apparatuses, storage media, and electronic devices, so as to solve a problem that a master node device cannot be elected from node devices within a determined time.

This specification uses the following technical solutions: This specification provides a node election method. The method is applied to any target node device among node devices, and the node devices each are configured to provide a database service. The method includes: A target node device determines status information of all node devices when detecting that a master node device in a current term meets a predetermined resignation condition; a candidate node device is determined from all the node devices based on the status information of all the node devices; and a voting request for electing the target node device as a master node device in a next term is broadcast to other node devices if it is determined that the candidate node device is the target node device; or broadcasting the voting request is skipped if it is determined that the candidate node device is another node device, and voting is performed for the another node device based on the determined candidate node device when a voting request that is broadcast by the another node device and that is for electing the another node device as the master node device in the next term is received.

Optionally, that a target node device detects that a master node device in a current term meets a predetermined resignation condition specifically includes: The target node device determines that the predetermined resignation condition is met when detecting that the term of the master node device in the current term expires and expiration duration exceeds set duration.

Optionally, that a candidate node device is determined from all the node devices based on the status information of all the node devices specifically includes: Status scores of all the node devices are determined based on the status information of all the node devices, and the candidate node device is determined from all the node devices based on the status scores of all the node devices.

Optionally, that status scores of all the node devices are determined based on the status information of all the node devices specifically includes: A status score of each node device is determined based on a priority of the node device becoming a master node device that is included in the status information of the node device.

Optionally, the method further includes: The priority of the target node device becoming a master node device is lowered if it is determined that a quantity of received status information broadcast by other node devices is less than a set quantity.

Optionally, that a status score of each node device is determined based on a priority of the node device becoming a master node device that is included in the status information of the node device specifically includes: The status score of each node device is determined based on the priority of the node device becoming a master node device and a random number generated by the node device, which are included in the status information of the node device, where a random number contained in status information broadcast by any node device every time is not exactly the same.

Optionally, that status scores of all the node devices are determined based on the status information of all the node devices specifically includes: If it is determined that each node device broadcasts status information based on a predetermined time interval, the status score of the node device is determined based on the status information broadcast by the node device.

Optionally, the method further includes: The target node device becomes a master node device in a next term if it is determined, based on voting information returned by other node devices based on the voting request, that a quantity of other node devices agreeing that the target node device becomes the master node device in the next term exceeds a set quantity.

Optionally, the method further includes: If it is detected that voting information of agreeing that the candidate node device becomes the master node device in the next term has been sent, sending voting information of agreeing that another node device other than the candidate node device becomes the master node device in the next term is skipped before appointment information sent by the another node device is received.

This specification provides a node election apparatus. The apparatus is applied to any target node device among node devices, and the node devices each are configured to provide a database service. The apparatus includes: a detection module, configured to determine, by a target node device, status information of all node devices when it is detected that a master node device in a current term meets a predetermined resignation condition; a determining module, configured to determine candidate node device from all the node devices based on the status information of all the node devices; a broadcasting module, configured to broadcast a voting request for electing the target node device as a master node device in a next term to other node devices if it is determined that the candidate node device is the target node device; and a voting module, configured to skip broadcasting the voting request if it is determined that the candidate node device is another node device, and vote for the another node device based on the determined candidate node device when a voting request that is broadcast by the another node device and that is for electing the another node device as the master node device in the next term is received.

This specification provides a computer-readable storage medium. The storage medium stores a computer program, and when the computer program is executed by a processor, the above-mentioned node election method is implemented.

This specification provides an electronic device, including a storage, a processor, and a computer program stored in the storage and capable of running on the processor, where when the processor executes the program, the above-mentioned node election method is implemented.

The above-mentioned at least one technical solution used in this specification can achieve the following beneficial effects: In the node election method according to this specification, a target node device determines status information of all node devices when detecting that a master node device in a current term meets a predetermined resignation condition. Then, a candidate node device is determined from all the node devices based on the status information of all the node devices. Then, a voting request for electing the target node device as a master node device in a next term is broadcast to other node devices if it is determined that the candidate node device is the target node device. Broadcasting the voting request is skipped if it is determined that the candidate node device is another node device, and voting is performed for the another node device based on the determined candidate node device when a voting request that is broadcast by the another node device and that is for electing the another node device as the master node device in the next term is received.

It can be seen from the above-mentioned method that, in the method, the candidate node device can be determined from all the node devices based on the status information of all the node devices, and the voting request is broadcast to other node devices if it is determined that the candidate node device is the target node device. If it is determined that the candidate node device is another node device, voting is performed for the another node device based on the determined candidate node device. Therefore, in a case that most node devices survive and communicate with each other, a master node device can be elected based on the status information of all the node devices within a determined time, thereby preventing a distributed system from being available for a long time.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart illustrating a node election method, according to some embodiments of this specification;

FIG. 2 is a schematic flowchart illustrating a node election, according to some embodiments of this specification;

FIG. 3 is a schematic diagram illustrating a structure of a node election apparatus, according to some embodiments of this specification; and

FIG. 4 is a schematic diagram illustrating a structure of an electronic device, according to some embodiments of this specification.

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of the embodiments of this specification. All other embodiments obtained by a person of ordinary skill in the art based on embodiments of this specification without creative efforts shall fall within the protection scope of this specification.

The following describes in detail the technical solutions provided in the embodiments of this specification with reference to the accompanying drawings.

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of the embodiments of this specification. All other embodiments obtained by a person of ordinary skill in the art based on embodiments of this specification without creative efforts shall fall within the protection scope of this specification.

The following describes in detail the technical solutions provided in the embodiments of this specification with reference to the accompanying drawings.

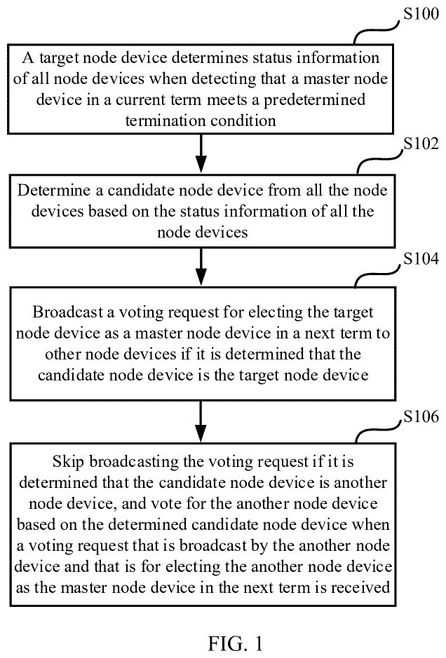

FIG. 1 is a schematic flowchart illustrating a node election method, according to this specification. The method specifically includes following steps S100 to S106.

S100: Status information of all node devices is determined when a target node device detects that a master node device in a current term meets a predetermined resignation condition.

In some embodiments of this specification, an execution body of the node election method may be a node device, and the node device may be an electronic device such as a server or a desktop computer. Because the method is applied to any target node device among node devices, for ease of description, the following uses only a target node device as an execution body to describe the node election method according to this specification.

In some embodiments of this specification, the target node device can determine the status information of all the node devices when detecting that the master node device in the current term meets the predetermined resignation condition. The status information mentioned here includes an identity of a node device. The identity of the node device mentioned here can refer to information such as an IP address, a port number, and a device number of the node device.

The target node device can receive status information broadcast by other node devices based on a set time interval, and query status information of the target node device, so as to determine the status information of all the node devices.

When detecting that the term of the master node device in the current term expires, the target node device determines that the master node device in the current term meets the predetermined resignation condition.

Further, because information needs to be transmitted between the node devices for certain transmission duration, the master node device may broadcast a request for extending the current term or a voting request for becoming a master node device for a next term when the current term is about to end. However, because of the transmission duration, no node devices receive the voting request in the current term. If it is determined whether to re-elect a master node device only based on whether the term of the master node device expires, the master node device in the current term may be unable to extend the current term or become the master node device in the next term. Therefore, when detecting that the term of the master node device in the current term expires and expiration duration exceeds set duration, the target node device determines that the master node device in the current term meets the predetermined resignation condition.

It is worthwhile to note that each node device in the embodiments of this specification is an honest node device. In other words, each node device sends information based on an actual situation.

S102: A candidate node device is determined from all the node devices based on the status information of all the node devices.

In practical applications, each node device determines whether to broadcast a request for electing the node device as a master node device to other node devices only based on whether a heartbeat message of the master node device is received, without considering status information of other node devices. If each of a plurality of node devices broadcasts, within a short time, a request for electing the node device as a master node device, a case that the plurality of node devices each cannot be agreed as a master node device by more than half of the node devices may occur. In this case, the node devices need to re-elect a master node device. However, in the re-election of a master node device, a case that each of the plurality of node devices broadcasts, within a short time, for electing the node device as a master node device may still occur. This causes the distributed system to be unavailable for a long time.

Based on this, the target node device can determine a candidate node device from all the node devices based on the status information of all the node devices. Therefore, in a case that most node devices survive and communicate with each other, a master node device is elected based on the status score of each node device within a determined time.

In some embodiments of this specification, the target node device can determine status scores of all the node devices based on the status information of all the node devices, and determine the candidate node device from all the node devices based on the status scores of all the node devices. For example, the target node device can determine a node device with a maximum status score among all the node devices as a candidate node device based on the status scores of all the node devices.

Specifically, the target node device can input the status information of all the node devices into a predetermined function to determine the status scores of all the node devices. The predetermined function mentioned here can be a one-to-one mapping from a non-empty number set to a non-empty number set. This specification does not limit the predetermined function, provided that a certain ordered set is output when the status information is input. The ordered set mentioned here can be a string, an integer, or the like. Certainly, the predetermined function may alternatively be designed based on a service need.

In some embodiments of this specification, the target node device can determine a status score of each node device based on a priority of the node device becoming a master node device that is included in the status information of the node device. The priority mentioned here can be determined by a person skilled in the art based on a service need. For example, the priority can be determined based on performance of a node device. Better performance of the node device indicates a higher priority of the node device becoming a master node device. For another example, the priority can be determined based on historical working duration of the node device. Longer historical working duration of the node device indicates a lower priority of the node device becoming a master node device. For another example, priorities of all the node devices each becoming a master node device are set to the same value.

Further, the target node device can input an identity of each node device and a priority of the node device becoming a master node device into the predetermined function to determine a status score of the node device. A higher priority of the node device becoming a master node device indicates a higher status score of the node device, while a lower priority of the node device becoming a master node device indicates a lower status score of the node device.

It is worthwhile to note that the predetermined function can be designed based on a need that a higher priority of becoming a master node device indicates a higher status score, while a lower priority of becoming a master node device indicates a lower status score.

In practical applications, if a node device has a poor network, the node device may receive no status information broadcast by other node devices, or receive a small quantity of status information broadcast by other node devices. This may cause the node device to believe the node device as a node device with a maximum status score, thereby sending a voting request for electing the node device as a master node device in the next term, resulting in a case that a plurality of node devices simultaneously elect the node devices as the master node device in the next term. Based on this, the node device can determine a quantity of status information of other node devices received by the node device. If the quantity is less than a set quantity, it can be determined that the node device has a poor current network, and therefore a priority of the node device becoming a master node device that is contained in the status information is lowered, to prevent other node devices from voting to the node device.

In some embodiments of this specification, if the target node device determines that the quantity of received status information broadcast by other node devices is less than the set quantity, the target node device lowers the priority of the target node device becoming a master node device. For example, if the target node device determines that the quantity of received status information broadcast by other node devices is less than the set quantity, the target node device lower the priority of the target node device becoming a master node device that is contained in the status information to the lowest level.

In practical applications, an identity of a node device and a priority of the node device becoming a master node device are generally fixed. The fixed identity of the node device and the fixed priority of the node device becoming a master node device are input into a predetermined function, and an obtained status score also does not change. This causes a node device with a maximum status score to always remain the master node device, so that overall efficiency of a distributed system is relatively low. Based on this, a value that changes can be added the status information of the node device, so as to solve a problem that the status score of the same node device does not change, resulting in relatively low overall efficiency of the distributed system.

In some embodiments of this specification, the target node device can determine a status score of each node device based on a priority of the node device becoming a master node device and a random number generated by the node device, which are contained in status information of the node device, where a random number contained in status information broadcast by any node device every time is not exactly the same. Therefore, each node device has the opportunity to become a master node device.

Further, the target node device can determine a status score of each node device based on an identity of the node device, a priority of the node device becoming a master node device, and a random number generated by the node device, which are included in status information of the node device.

In practical applications, if a node device with a maximum current status score fails after the node device broadcasts status information of the node device, and the node device cannot become a master node device due to a failure after other node devices vote for the node device, an entire failure of the distributed system may be caused. Based on this, each node device needs to broadcast status information of the node device based on a predetermined time interval, and only a status score of each node device that broadcasts status information of the node device based on the predetermined time interval is determined, so as to avoid voting for a failed node device.

In some embodiments of this specification, if the target node device determines that each node device broadcasts status information based on a predetermined time interval, the target node device determines a status score of the node device based on the status information broadcast by the node device.

If the target node device determines that the node device broadcasts no status information based on the predetermined time interval, the target node device does not determine the status score of the node device and invalidates historical status information of the node device.

Specifically, a first time interval and a second time interval are predetermined, and the second time interval is greater than the first time interval. The target node device determines, based on the status information of each node device received in the second time interval, node devices that broadcast no status information of the node devices based on the first time interval in the second time interval, and invalidates status information of node devices that broadcast no status information of the node devices based on the first time interval.

In practical applications, a current election algorithm needs to perform clock synchronization between node devices. If there is a relatively large clock deviation between the node devices, the current election algorithm may not work. In some embodiments of this specification, each node device can broadcast status information of the node device based on a set time interval to detect whether a term of a master node expires. Since each node device elects a master node device based on a time interval, dependence on clock synchronization is avoided.

S104: A voting request for electing the target node device as a master node device in a next term is broadcast to other node devices if it is determined that the candidate node device is the target node device.

S106: Broadcasting the voting request is skipped if it is determined that the candidate node device is another node device, and voting is performed for the another node device based on the determined candidate node device when a voting request that is broadcast by the another node device and that is for electing the another node device as the master node device in the next term is received.

In some embodiments of this specification, the target node device broadcasts a voting request for electing the target node device as a master node device in a next term to other node devices if it is determined that the candidate node device is the target node device. In other words, if the target node device determines that the target node device is a node device with a maximum status score, the target node device sets the target node device as the master node device in the next term, and broadcasts a voting request for electing the voting request as the master node device in the next term to other node devices.

Then, the target node device becomes the master node device in the next term if it is determined, based on voting information returned by other node devices based on the voting request, that a quantity of other node devices agreeing that the target node device becomes the master node device in the next term exceeds a set quantity. The set quantity mentioned here can refer to a quantity greater than half of a total quantity of node devices.

Certainly, the target node device can broadcast appointment information of the target node device as the master node device after becoming the master node device in the next term. The appointment information mentioned here can be used to inform other node devices that the target node device has become the master node device. The appointment information further includes term information of the target node device, such as start time of the target node device becoming the master node, end time of the target node device becoming the master node, and duration of the target node device becoming the master node.

In some embodiments of this specification, the target node device skips broadcasting the voting request if it is determined that the candidate node device is another node device, and votes for the another node device based on the determined candidate node device when a voting request that is broadcast by the another node device and that is for electing the another node device as the master node device in the next term is received.

In other words, if the target node device determines that the target node device is not a node device with a maximum status score, the target node device does not set the target node device as the master node device in the next term, and receives voting requests broadcast by other node devices. Then, the target node device can determine another node device with a maximum status score from the received voting requests within a predetermined voting time, and send voting information of agreeing that the another node device becomes the master node device to the another node device with the maximum status score.

It is worthwhile to note that a node device can broadcast a voting request to elect the node device as the master node device in the next term. The node device may alternatively broadcast a voting request to elect the candidate node device determined by the node device as the master node device in the next term.

In practical applications, network fluctuation may occur in each node device, resulting in a case that the node device only receives status information of some of the node devices or receives status information of the node devices in batches (first receives status information of some node devices, and then receives status information of some other node devices). In the case of network fluctuations, the target node device first receives the status information of some node devices, and determines a candidate node device based on these node devices. In this case, if the target node device receives a voting request that is broadcast by the candidate node device and that is for electing as the master node device in the next term, the target node device sends voting information of agreeing that the candidate node device becomes the master node device in the next term to the candidate node device.

After sending the voting information, the target node device also receives status information of some other node devices. If the target node device determines another node device with a higher status score than that of the candidate node device with reference to the obtained status information of some other node devices, and subsequently receives a voting request that is broadcast by the another node device and that is for electing as the master node device in the next term, the target node device continues to send voting information of agreeing that the another node device becomes the master node device in the next term to the another node device. As such, there will be a plurality of master node devices, which will lead to the failure of the distributed system.

To avoid the above-mentioned situation, after the target node device has sent the voting information of agreeing that the candidate node device becomes the master node device in the next term, the target node device does not send voting information to another node device even if the target node device receives a voting request that is broadcast by the another node device and that is for electing as the master node device in the next term.

In other words, the target node device skips sending, if it is detected that voting information of agreeing that the candidate node device becomes the master node device in the next term has been sent, voting information of agreeing that another node device other than the candidate node device becomes the master node device in the next term before appointment information sent by the another node device is received. By this method, the node device can only vote once in each round of voting time, thereby ensuring that the master node device in the next term can be successfully elected in the round of voting and ensuring the normal operation of the distributed system.

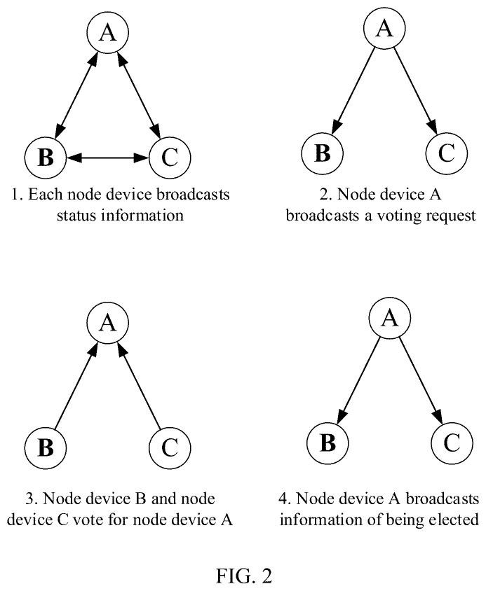

FIG. 2 is a schematic flowchart illustrating a node election, according to some embodiments of this specification. In FIG. 2, it is assumed that node device A has a maximum status score. Node device A, node device B and node device C broadcast their own status information based on predetermined time intervals respectively, and receive status information broadcast by other node devices. If node device A detects that the term of the master node device expires and expiration duration exceeds set duration, and node device A determines that node device A has a maximum status score, node device A is taken as a candidate node device, and broadcasts a voting request for electing node device A as the master node device in the next term to other node devices. After the voting request broadcast by node device A is received, if it is determined that the term of the master node device expires and the expiration duration exceeds the set duration, and node device A has a maximum status score, node device B and node device C send voting information of agreeing that node device A becomes the master node device in the next term to node device A, with node device A as a candidate node device. Within a predetermined voting time, node device A receives voting information of agreeing that node device A becomes the master node device in the next term, which is sent by node device B and node device C, and after determining that a quantity of voting information of agreeing that node device A becomes the master node device in the next term exceeds half of a total quantity of node devices, node device A becomes the master node device in the next term, and broadcasts appointment information of the node device A as the master node device.

It can be seen from the above-mentioned process that, in the method, the candidate node device can be determined from all the node devices based on the status information of all the node devices, and the voting request is broadcast to other node devices if it is determined that the candidate node device is the target node device. If it is determined that the candidate node device is another node device, voting is performed for the another node device based on the determined candidate node device. Therefore, in a case that most node devices survive and communicate with each other, a master node device can be elected based on the status information of all the node devices within a determined time, thereby preventing a distributed system from being available for a long time.

The above is a node election method according to some embodiments of this specification. Based on the same idea, this specification further provides a corresponding apparatus, a storage medium, and an electronic device.

FIG. 3 is a schematic diagram illustrating a structure of a node election apparatus, according to some embodiments of this specification. The apparatus is applied to any target node device among node devices, and the node devices each are configured to provide a database service. The apparatus includes: a detection module 300, configured to determine, by a target node device, status information of all node devices when it is detected that a master node device in a current term meets a predetermined resignation condition; a determining module 302, configured to determine candidate node device from all the node devices based on the status information of all the node devices; a broadcasting module 304, configured to broadcast a voting request for electing the target node device as a master node device in a next term to other node devices if it is determined that the candidate node device is the target node device; and a voting module 306, configured to skip broadcasting the voting request if it is determined that the candidate node device is another node device, and vote for the another node device based on the determined candidate node device when a voting request that is broadcast by the another node device and that is for electing the another node device as the master node device in the next term is received.

Optionally, the detection module 300 is specifically configured to determine, by the target node device, that the predetermined resignation condition is met when it is detected that the term of the master node device in the current term expires and expiration duration exceeds set duration.

Optionally, the determining module 302 is specifically configured to determine status scores of all the node devices based on the status information of all the node devices, and determine the candidate node device from all the node devices based on the status scores of all the node devices.

Optionally, the determining module 302 is specifically configured to determine a status score of each node device based on a priority of the node device becoming a master node device that is included in the status information of the node device.

Optionally, the determining module 302 is specifically further configured to lower the priority of the target node device becoming a master node device if it is determined that a quantity of received status information broadcast by other node devices is less than a set quantity.

Optionally, the determining module 302 is specifically configured to determine the status score of each node device based on the priority of the node device becoming a master node device and a random number generated by the node device, which are included in the status information of the node device, where a random number contained in status information broadcast by any node device every time is not exactly the same.

Optionally, the determining module 302 is specifically configured to determine, if it is determined that each node device broadcasts status information based on a predetermined time interval, the status score of the node device based on the status information broadcast by the node device.

Optionally, the voting module 306 is specifically further configured to cause the target node device to become a master node device in a next term if it is determined, based on voting information returned by other node devices based on the voting request, that a quantity of other node devices agreeing that the target node device becomes the master node device in the next term exceeds a set quantity.

Optionally, the voting module 306 is specifically further configured to skip sending, if it is detected that voting information of agreeing that the candidate node device becomes the master node device in the next term has been sent, voting information of agreeing that another node device other than the candidate node device becomes the master node device in the next term before appointment information sent by the another node device is received.

This specification further provides a computer-readable storage medium. The storage medium stores a computer program, and the computer program, when executed by a processor, can be used to perform the node election method provided in FIG. 1.

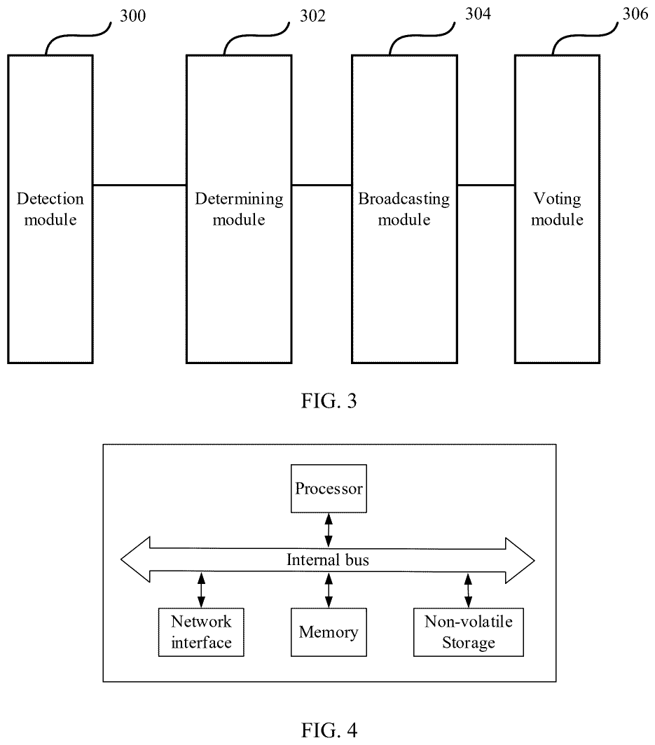

Some embodiments of this specification further provide a schematic diagram illustrating a structure of an electronic device shown in FIG. 4. As shown in FIG. 4, in terms of hardware, the electronic device includes a processor, an internal bus, a network interface, a memory, and a nonvolatile memory, and certainly may further include hardware needed by another service. The processor reads a corresponding computer program from the nonvolatile memory into the memory and then runs the computer program, to implement the node election method provided in FIG. 1.

Certainly, in addition to software implementations, another implementation is not excluded in this specification, for example, a logic device or a combination of hardware and software. In other words, an execution body of the following processing procedures is not limited to logical units, and can be hardware or a logic device.

It is worthwhile to note that all actions of obtaining a signal, information, or data in this specification are performed in compliance with corresponding data protection regulations and policies of local countries, and are authorized by an owner of a corresponding apparatus.

In the 1990s, improvements to a technology could clearly be distinguished as improvements in hardware (for example, improvements to circuit structures such as diodes, transistors, and switches) or software (improvements to method procedures). However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a specific programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the above-mentioned several hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The storage controller can alternatively be implemented as a part of control logic of the storage. A person skilled in the art also knows that, in addition to implementing the controller by using only computer-readable program code, logic programming can be performed on a method step, so the controller implements a same function in a form of a logic gate, a switch, an application-specific integrated circuit, a programmable logic controller, an embedded microcontroller, etc. Therefore, the controller can be considered as a hardware component, and an apparatus included in the controller and configured to implement various functions can also be considered as a structure in the hardware component. Or the apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a certain function. A typical implementation device is a computer. Specifically, for example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, this specification can use a form of a computer program product that is implemented on one or more computer-usable storage media (including but not limited to a disk storage, a CD-ROM, an optical storage, or the like) that include computer-usable program code.

This specification is described with reference to flowcharts and/or block diagrams of a method, a device (system), and a computer program product according to embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specified function in one or more procedures in the flowcharts and/or in one or more blocks in the block diagrams.

These computer program instructions can alternatively be stored in a computer-readable memory that can instruct a computer or another programmable data processing device to work in a specific way, so that an instruction stored in the computer-readable memory generates an artifact including an instruction apparatus, and the instruction apparatus implements a specified function in one or more procedures in the flowcharts and/or one or more blocks in the block diagrams.

The computer program instructions can alternatively be loaded onto a computer or another programmable data processing device, so that a series of operations and steps are performed on the computer or the another programmable device, and therefore computer-implemented processing is generated. Therefore, the instructions executed on the computer or the another programmable device provide steps for implementing a specified function in one or more procedures in the flowcharts and/or in one or more blocks in the block diagrams.

In a typical configuration, a computing device includes one or more processors (CPUs), an input/output interface, a network interface, and a memory.

The memory may include a form such as a non-permanent memory, a random access memory (RAM), and/or a nonvolatile memory in a computer-readable medium, for example, a read-only memory (ROM) or a flash memory (flash RAM). The memory is an example of the computer-readable medium.

Computer-readable media, including permanent and non-permanent, removable and non-removable media, can implement information storage by any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory computer-readable media (transitory media) such as a modulated data signal and carrier.

It should be further noted that the terms “include”, “comprise”, or any other variants thereof are intended to cover a non-exclusive inclusion, so that a process, method, product, or device that includes a list of elements not only includes those elements but also includes other elements which are not expressly listed, or further includes elements inherent to such a process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, this specification can use a form of a computer program product that is implemented on one or more computer-usable storage media (including but not limited to a disk storage, a CD-ROM, an optical storage, or the like) that include computer-usable program code.

This specification can be described in a general context of a computer-executable instruction executed by a computer, for example, a program module. Generally, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environment, a program module can be located in local and remote computer storage media including a storage device.

The embodiments of this specification are described in a progressive manner. For same or similar parts in the embodiments, mutual reference can be made to the embodiments. Each embodiment focuses on a difference from other embodiments. Particularly, the system embodiments are basically similar to the method embodiments, and therefore are briefly described. For a related part, reference can be made to some descriptions in the method embodiments.

The above-mentioned descriptions are merely embodiments of this specification and are not intended to limit this specification. A person skilled in the art can make various changes and variations to this specification. Any modification, equivalent replacement, improvement, etc. made without departing from the spirit and principle of this specification shall fall within the scope of the claims in this specification.

1. A node election method, wherein the method is applied to any target node device among node devices, the node devices each are configured to provide a database service, and the method comprises:
determining, by a target node device, status information of all node devices when it is detected that a master node device in a current term meets a predetermined resignation condition;
determining a candidate node device from all the node devices based on the status information of all the node devices; and
broadcasting a voting request for electing the target node device as a master node device in a next term to other node devices upon determining that it is determined that the candidate node device is the target node device, or
skipping broadcasting the voting request upon determining that it is determined that the candidate node device is another node device, and voting for the another node device based on the determined candidate node device when a voting request that is broadcast by the another node device and that is for electing the another node device as the master node device in the next term is received.

2. The method according to claim 1, wherein detecting, by the target node device, that the master node device in the current term meets the predetermined resignation condition specifically comprises:
determining, by the target node device, that the predetermined resignation condition is met when it is detected that the term of the master node device in the current term expires and expiration duration exceeds set duration.

3. The method according to claim 1, wherein determining the candidate node device from all the node devices based on the status information of all the node devices specifically comprises:
determining status scores of all the node devices based on the status information of all the node devices, and determining the candidate node device from all the node devices based on the status scores of all the node devices.

4. The method according to claim 3, wherein determining the status scores of all the node devices based on the status information of all the node devices specifically comprises:
determining a status score of each node device based on a priority of the node device becoming a master node device that is comprised in the status information of the node device.

5. The method according to claim 4, wherein the method further comprises:
lowering the priority of the target node device becoming a master node device upon determining that it is determined that a quantity of received status information broadcast by other node devices is less than a set quantity.

6. The method according to claim 4, wherein determining the status score of each node device based on a priority of the node device becoming a master node device that is comprised in the status information of the node device specifically comprises:
determining the status score of each node device based on the priority of the node device becoming a master node device and a random number generated by the node device, which are comprised in the status information of the node device, wherein a random number contained in status information broadcast by any node device every time is not exactly the same.

7. The method according to claim 3, wherein determining the status scores of all the node devices based on the status information of all the node devices specifically comprises:
determining, upon determining that it is determined that each node device broadcasts status information based on a predetermined time interval, the status score of the node device based on the status information broadcast by the node device.

8. The method according to claim 1, wherein the method further comprises:
allowing the target node device to become the master node device in the next term upon determining that it is determined, based on voting information returned by other node devices based on the voting request, that a quantity of other node devices agreeing that the target node device becomes the master node device in the next term exceeds a set quantity.

9. The method according to claim 1, wherein the method further comprises:
skipping sending, upon determining that it is detected that voting information of agreeing that the candidate node device becomes the master node device in the next term has been sent, voting information of agreeing that another node device other than the candidate node device becomes the master node device in the next term before appointment information sent by the another node device is received.

10. (canceled)

11. A non-transitory computer-readable storage medium, wherein the storage medium stores a computer program, and when the computer program is executed by a processor, the processor is caused to implement a node election method, wherein the method is applied to any target node device among node devices, the node devices each are configured to provide a database service, and the method comprises:
determining, by a target node device, status information of all node devices when it is detected that a master node device in a current term meets a predetermined resignation condition;
determining a candidate node device from all the node devices based on the status information of all the node devices; and
broadcasting a voting request for electing the target node device as a master node device in a next term to other node devices upon determining that it is determined that the candidate node device is the target node device, or
skipping broadcasting the voting request upon determining that it is determined that the candidate node device is another node device, and voting for the another node device based on the determined candidate node device when a voting request that is broadcast by the another node device and that is for electing the another node device as the master node device in the next term is received.

12. An electronic device, comprising a storage, a processor, and a computer program stored in the storage and capable of running on the processor, wherein when the processor executes the program, the electronic device is caused to implement a node election method, wherein the method is applied to any target node device among node devices, the node devices each are configured to provide a database service, and the method comprises:
determining, by a target node device, status information of all node devices when it is detected that a master node device in a current term meets a predetermined resignation condition;
determining a candidate node device from all the node devices based on the status information of all the node devices; and
broadcasting a voting request for electing the target node device as a master node device in a next term to other node devices upon determining that it is determined that the candidate node device is the target node device, or
skipping broadcasting the voting request upon determining that it is determined that the candidate node device is another node device, and voting for the another node device based on the determined candidate node device when a voting request that is broadcast by the another node device and that is for electing the another node device as the master node device in the next term is received.

13. The electronic device according to claim 12, wherein detecting, by the target node device, that the master node device in the current term meets the predetermined resignation condition specifically comprises:
determining, by the target node device, that the predetermined resignation condition is met when it is detected that the term of the master node device in the current term expires and expiration duration exceeds set duration.

14. The electronic device according to claim 12, wherein determining the candidate node device from all the node devices based on the status information of all the node devices specifically comprises:
determining status scores of all the node devices based on the status information of all the node devices, and determining the candidate node device from all the node devices based on the status scores of all the node devices.

15. The electronic device according to claim 14, wherein determining the status scores of all the node devices based on the status information of all the node devices specifically comprises:
determining a status score of each node device based on a priority of the node device becoming a master node device that is comprised in the status information of the node device.

16. The electronic device according to claim 15, wherein the node election method further comprises:
lowering the priority of the target node device becoming a master node device upon determining that it is determined that a quantity of received status information broadcast by other node devices is less than a set quantity.

17. The electronic device according to claim 15, wherein determining the status score of each node device based on a priority of the node device becoming a master node device that is comprised in the status information of the node device specifically comprises:
determining the status score of each node device based on the priority of the node device becoming a master node device and a random number generated by the node device, which are comprised in the status information of the node device, wherein a random number contained in status information broadcast by any node device every time is not exactly the same.

18. The electronic device according to claim 14, wherein determining the status scores of all the node devices based on the status information of all the node devices specifically comprises:
determining, upon determining that it is determined that each node device broadcasts status information based on a predetermined time interval, the status score of the node device based on the status information broadcast by the node device.

19. The electronic device according to claim 12, wherein the node election method further comprises:
allow the target node device to become the master node device in the next term upon determining that it is determined, based on voting information returned by other node devices based on the voting request, that a quantity of other node devices agreeing that the target node device becomes the master node device in the next term exceeds a set quantity.

20. The electronic device according to claim 12, wherein the node election method further comprises:
skipping sending, upon determining that it is detected that voting information of agreeing that the candidate node device becomes the master node device in the next term has been sent, voting information of agreeing that another node device other than the candidate node device becomes the master node device in the next term before appointment information sent by the another node device is received.

21. The non-transitory computer-readable storage medium according to claim 11, wherein detecting, by the target node device, that the master node device in the current term meets the predetermined resignation condition specifically includes being caused to:
determining, by the target node device, that the predetermined resignation condition is met when it is detected that the term of the master node device in the current term expires and expiration duration exceeds set duration.
